(19) United States
(12) Patent Application Publication
(10) Pub. No.: US 2024/0061111 A1
(43) Pub. Date: Feb. 22, 2024

(54) PHASE UNWRAPPING SIGNAL PROCESSING UNIT WITH FLEXIBLE DOUBLE FREQUENCIES

(71) Applicant: GM Cruise Holdings LLC, San Francisco, CA (US)

(72) Inventors: Zhanping Xu, Sunnyvale, CA (US); Glenn D. Sweeney, Sebastopol, CA (US); Brandon S. Seilhan, San Ramon, CA (US); Juan Sebastian Hurtado Jaramillo, San Francisco, CA (US); Kartheek Chandu, Dublin, CA (US)

(21) Appl. No.: 17/891,463

(22) Filed: Aug. 19, 2022

(51) Int. Cl. G01S 17/08; G01S 13/08; G01S 17/931; G01S 13/931

(52) U.S. Cl. CPC G01S 17/08; G01S 13/08; G01S 17/931; G01S 13/931

(57) ABSTRACT

The present disclosure is directed to a detection device that avoids using frequencies that can potentially interfere with the operation of other electronic devices. An apparatus consistent with the present disclosure may use electrical signals of different frequencies to generate sensing signals that may be electromagnetic signals in the light spectra, for example, infrared signals may be used. Operational frequencies selected may include at least one frequency that is represented as an irrational number.

### BACKGROUND

### 1. Technical Field

The present disclosure is generally directed to improving operation of a detection apparatus. More specifically the present disclosure is directed to the unwrapping of received signals while mitigating the possibility of generating electromagnetic waves that can interfere with other electronic devices.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors, and radar elements disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a set of images that associate phase changes in signals with wrapped phase degrees.

FIG. 2 illustrates sets of overlapped curves that represent how a “rectification” process may be used to help unwrap sets of wrapped data.

FIG. 3 illustrates a curve that is similar to the curve of FIG. 2 except that the vertical axis of FIG. 3 identifies index values instead of degrees of wrapped phases.

FIG. 4 illustrates another set of curves that show a correspondence between phase in degrees and an unwrapped cycle index of the 18.75 MHz and 24 MHz signals.

FIG. 5 illustrates that values of certain variables (CL and CH) may be used to generate other phase diagrams representing phase relationships between the signals, according to some aspects of the disclosed technology.

FIG. 6 illustrates a series of curves that represent propagating signals, according to some aspects of the disclosed technology.

FIG. 7 illustrates a series of steps that may be performed by a detection apparatus using frequencies that may have been classified as non-interfering frequencies.

FIG. 8 shows an example computing system that may be used to implement at least some of the functions reviewed in the present disclosure.

FIG. 9 illustrates an example of an AV management system.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Detection devices used in AVs often are required to use high frequency electrical signals that may be used to generate signals used to identify the location of objects near an AV. Electrical signals used in these detection devices may result in emissions of electromagnetic energy that can sometimes interfere with other electronic devices. Even when light signals are used to detect objects, electrical signals used to generate these light signals may be inadvertently radiated from a detection device. Since electromagnetic energy escaping from a detection device may interfere with the operation of other electronic devices, what are needed are new methods and systems for preventing detection devices from emitting electromagnetic energy that can interfere with other electronic devices.

One problem associated with electronic equipment today relates to electromagnetic signals emitted from one electronic device interfering with another electronic device. Electromagnetic signals that are required for an electronic device to operate naturally generate electromagnetic waves or fields. Changing electrical signals generated by an electronic device naturally generate and emit electromagnetic waves that have a frequency (i.e., repetition rate) that corresponds to a signal frequency or harmonics of a signal. When an emitted electromagnetic field generated by a first electronic device moves through space and into a second electronic device, electrical currents may induce voltages in traces or electrical contacts of the second electronic device. Such induced electromagnetic currents can increase electrical noise and can cause an electronic device to error or fail. This risk tends to increase significantly with power consumption.

General terms used in the art of controlling or measuring electromagnetic waves/fields include electromagnetic interference (EMI) and electromagnetic compatibility (EMC). Here EMI is the interference discussed above that causes increased electrical noise or that can cause an electronic device to error or fail. The term electromagnetic compatibility (EMC) refers to designing electronic equipment to mitigate the generation or transmission of electromagnetic signals or to designing electronic equipment in some way that makes an electronic device less susceptible to EMI. A laser ranging detection device, for example, emits light energy based on one or more sets of high frequency electronic signals included driving a laser or light emitter. Since detection devices tend to use greater amounts of power than other devices, detection devices are more likely to emit EMI that can interfere with operation of these other devices.

Methods and apparatuses consistent with the present disclosure may use two or more different frequencies of light to increase an effective range of a light-based detection device while providing an acceptable range detection resolution. This may include emitting light energy at different frequencies, receiving signals that are reflections of that light energy, and implementing a specialized form of unwrapping data when interpreting the received signals.

Frequencies likely to be used by electronic equipment may be included in a list of “forbidden frequencies.” Alternatively, or additionally, a list of “allowed frequencies” may be generated. Such lists may be used to identify specific frequencies that are classified as being “allowed frequencies.” Such forbidden frequencies may be frequencies that are used by other types of electronic equipment (e.g., cell phones or global positioning devices), where allowed frequencies may be frequencies that are not used by other types of electronic equipment. Allowed frequencies may also include frequencies that have harmonics that are also not used by the other types of electronic equipment.

As mentioned above, electromagnetic energy emitted from a device that includes the same frequency used by other types of electronic equipment are more likely to interfere with operation of electronic devices that use that same frequency. Allowed frequencies could include frequencies within a frequency rage (e.g., 18.26 to 18.33 megahertz (MHz), 18.68 to 18.78 MHz, 23.01 to 23.15 MHz, 23.4 to 23.5 MHz, and 23.7 to 23.85 MHz or could include a single frequency (e.g. 23.98 MHz). Specific frequencies selected from these allowed frequencies may be used by a range detection apparatus to help mitigate the possibility of interfering with the operation of other electronic devices.

Different types of electromagnetic (e.g. light or radio frequency) signals propagate through space at a speed of light which is about 2.998*10\hat{ }8 meters per second (2.998 times ten to the eighth power). Since electromagnetic energy travels as a wave that may have a shape of a sinusoid (i.e. a sine wave) that starts with a zero magnitude when the phase of that wave is at zero degrees. The phase of that wave then increases to a maximum magnitude when the phase of the wave is equal to 90 degrees. Between 90 degrees and 180 degrees the magnitude of the wave changes from the maximum magnitude back to the zero magnitude. Between 180 degrees and 270 degrees the magnitude of the wave changes from the zero magnitude to a minimum magnitude and between 270 degrees and 360 degrees the magnitude of the wave changes from the minimum magnitude back to the zero magnitude. Cycles of such a wave then repeat continuously for every period. The length of such a period may be referred to as a wavelength. The length of a period corresponds to the inverse of a frequency of the wave times the speed at which the wave moves (which is the speed of light). This length (of a period or wavelength) for a given frequency signal may be calculated by multiplying the speed that the wave travels (by the speed of light) times the inverse of the wave frequency.

Because of this, a 24 MHz signal has a wavelength with a period of 1/(24*10\hat{ }6), which equals 0.041667×10\hat{ }−6 seconds (or 4.1667*10\hat{ }−8 seconds). A time that the 24 MHz wave takes to move over this period length may be calculated by multiplying the period by the speed of light. For this 24 MHz wave, this time would equal (4.1667×10\hat{ }−8 meters)*(2.998*10\hat{ }8 meters per second) or 12.49 meters. Similar calculations could be performed to determine the time that it takes for other frequencies of electromagnetic waves to travel through a single wavelength. Since the time that it takes for an electromagnetic wave to travel in a single period is inversely proportional to frequency, lower frequency electromagnetic signals must travel farther than higher frequency electromagnetic signals to complete a cycle/wavelength.

Based on the correlation technique we can process the distance related phase. For instance, the correlations signal of a time of flight (TOF) sensor has the same repeating cycle as the modulation frequency incorporated with the phase shifting method. The modulation waveform can be any periodical signal (e.g., square wave or sinusoidal wave). The correlation result of two sinusoidal signals of transmission channel and receiving channel is also a sinusoidal signal. To simplify the description without losing generality we assume the correlation signal used for the phase evaluation is sinusoidal. Detection devices that transmit electromagnetic signals and receive reflections of that transmitted electromagnetic signals use phase changes between the transmitted and the received electromagnetic signals to identify locations of objects that reflected the received electromagnetic signals. Such detection devices may include a transceiver that transmits and receives electromagnetic signals. Such transceivers may include one or more transmitting elements and one or more receiving elements. Since electromagnetic signals repeat phase relationships over time, such detection devices cannot discern an absolute distance to an object when electromagnetic signals of a single frequency are used. This is because the phase of a signal will be the same at multiples of a period associated with that signal. Changes in the phase of a signal may be used to identify possible locations of an object. Since the phase relationship of a single frequency signal repeats every time the sine wave moves through a new period, the use of phase relationships of a signal can only identify possible locations of an object. For example, when an object is located 5 meters from a detection device using signals that have a period of 4 meters, the detection device could identify that the object is located at a place associated with a phase angle of 90 degrees. This 90-degree phase relationship repeats every four meters, at 1 meter, 5 meters, 9 meters, 13 meters, and 16 meters from the detection device. This means that detection devices that rely upon the use of phase changes of a single frequency will not be able to identify an actual location of the object. This ambiguity may be referred to as a wrapping effect associated with a single frequency. A detection device that uses multiple different frequencies, however, can process received signals using an “unwrapping” process to identify an actual location of the object. Since electromagnetic signals used by detection devices must travel from the detection device to an object and then back to the detection device, distances that may be associated with a detection distance are half of the distance that an electromagnetic signal travels.

The ambiguity discussed above may be resolved by using two different frequencies of electromagnetic signals. Since one goal of the present disclosure is to avoid using “forbidden frequencies” only frequencies that are classified as being “allowed” are used to meet this goal. In order to meet this goal, in an instance when multiple signal frequencies are used, at least one of those frequencies are selected based on that frequency corresponding to an irrational number or non-integer. Implementations that use two different frequencies where each of those frequencies correspond to a rational number (e.g. an integer) cannot always avoid using a “forbidden frequency.” As such, methods of the present disclosure may use two frequencies, where at least one of these frequencies correspond to a non-rational number (i.e. a number that is not an integer). Furthermore, devices built using program code that requires the use of frequencies that correspond to rational numbers or their frequency ratio is a rational number composed of two adjacent rational integer numbers would fail if a frequency that corresponds to an irrational number were used. Such adjacent rational integer numbers may also be referred to as adjacent rational numbers or rational numbers that are numbers that can be written in the form of P/Q, where Q does not equal zero and where P and Q are both integers.

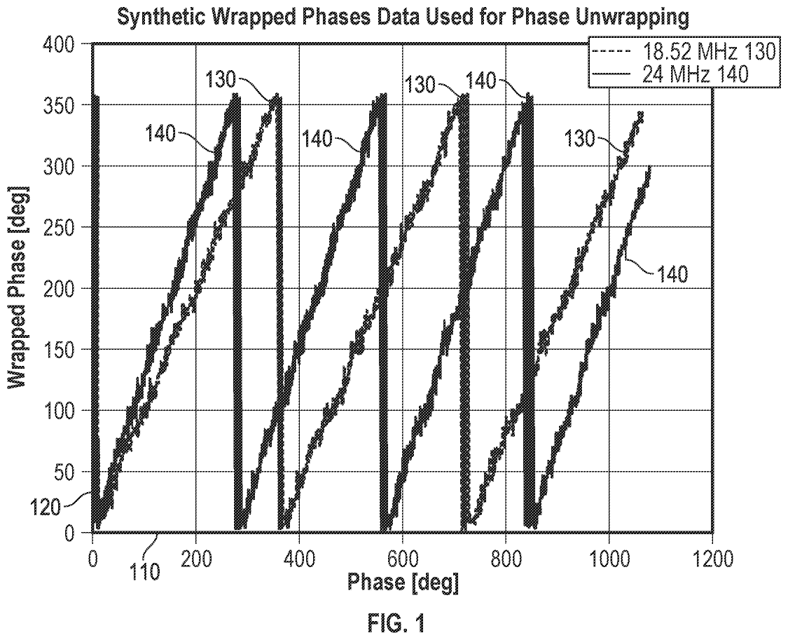

FIG. 1 illustrates a set of images that associate phase changes in signals with wrapped phase degrees. FIG. 1 includes a horizontal axis 110 that identifies a phase change in degrees and a vertical axis 120 of a “wrapped phase” in degrees. FIG. 1 also includes a first set of curves 130 associated with a lower frequency and a second set of curves 140 associated with a higher frequency. In a phase mapping of a particular signal, points in that mapping where the phase of the vertical axis begins rising from 0 degrees corresponds to a beginning of a wrapping for that signal and points in that mapping where the phase of the vertical axis changes from 360 degrees to 0 degrees corresponds to an ending that that wrapping. Here, the frequency associated with the first set of curves is 18.75 MHz (an irrational or non-integer value of frequency) and the frequency associated with the second set of curves is 24 MHz. Each of these sets of curves 130 and 140 are associated with several cycles of different frequencies that repeat. Note that FIG. 1 includes more than three wrappings of phase relationships of a 24 MHz frequency signal as indicated by curve 140 and includes nearly 3 wrappings of an 18.75 MHz signal as indicated by curve 130. Each cycle of these curve begins with a line that increases until abruptly dropping and beginning to increase again. Locations where the first set of curves 130 begin to rise and/or abruptly drop correspond to degrees 0, 360, and 720 degrees of the 18.75 MHz frequency of the horizontal axis and 0 degrees or 360 degrees of the vertical axis. Locations where the second set of curves 140 begin to rise and/or abruptly drop correspond to 0 degrees or 360 degrees of the vertical axis for the 24 MHz frequency and some other number of degrees of the horizontal axis.

Since both the 18.75 MHz signal and the 24 MHz signal travel at the same speed and change phase corresponding to a sine wave, phase relationships between the two different frequencies over a time span correspond to a ratio associated with the frequencies or periods associated with the 18.75 MHz and the 24 MHz signals. This may be demonstrated using a few evaluations that follow below.

In the time it takes for the phase of a 24 MHz signal to change from 0 degrees to 360 degrees, the 24 MHz signal will travel a distance that is equal the wavelength of the 24 MHz signal. The time it takes for a signal of a given frequency to travel one wavelength is its period, i.e., 1/F, which results in a value of 4.16667*10\hat{ }−8 seconds for the 24 MHz signal. The time it takes for the phase of the 18.75 MHz signal to change from 0 degrees to 360 degrees is 5.33333*10\hat{ }(−8) seconds. Ratios associated with these times are 4.16667/5.33333=0.781 and 5.33333/4.16667=1.28 and ratios associated with the 18.75 MHz and 24 MHz signals are 18.75/24=0.781 and 24/18.75=1.28—These evaluations result in identical ratios and are slightly different here because of roundoff error as the formulaic determination demonstrates below. Note that the ratio of F2/F1=24/18.75 results in a value that is not a rational number composed of two adjacent integers as F1 of 18.75 is not an integer.

This same determination is demonstrable using formulas: the time it takes for each respective signal frequency to change from 0 degrees to 360 degrees for a first frequency F1 and a second frequency F2 are identified by the equations T1=[1/F1] and T2=[1/F2]. A time ratio associated with each of these times T1/T2=[1/F1]/[1/F2]=1/F1*F2=F2/F1 | Similarly T2/T1=F1/F2.

Referring back to curve 130 of FIG. 1, the rising of the changes in the phase and the abrupt changes associated with a phase change in the signal at 0 degrees, 360 degrees, and 720 degrees of the horizontal axis of FIG. 1. This means that curve 140 repeats at 281.25 degrees in an ideal case without noise: 281.25 degrees, at 562.5 degrees, and 843.75 degrees of the horizontal axis of FIG. 1. This also means that in the time it takes the 24 MHz signal—curve 140—to complete cycles (from 0 degrees to 360 degrees of the vertical axis), the phase of the 18 MHz signal changes by 281.25 degrees as the 24 MHz signal has a shorter period than the 18.75 MHz signal.

Note that with each respective cycle of curves 130 and 140 of FIG. 1 have unique phase differences that are identifiable by the intersection of horizontal lines drawn perpendicular to vertical axis 120 at points where both curves 130 and 140 rise. Such phase differences do not repeat or cross over during the 2-3 cycles of curves 130 and 140 illustrated in FIG. 1. This means that distances to an object may be identified within some acceptable or threshold level of accuracy using frequencies that do not have integer relationships with each other within at least some time span and distance. This also allows frequencies used in a detection apparatus to be compatible with any set of requirements defined by law, regulation (e.g. a set of FCC rules), convention, or practice. Another issue that a designer must consider is electrical noise and how that noise could potentially affect a detection apparatus. In an ideal case, phase relationships during these several cycles between the 24 MHz signal and the 18.75 MHz signal will be unique. Electrical noise, however, could cause measured phase relationships to not be unique when measured by a detection device.

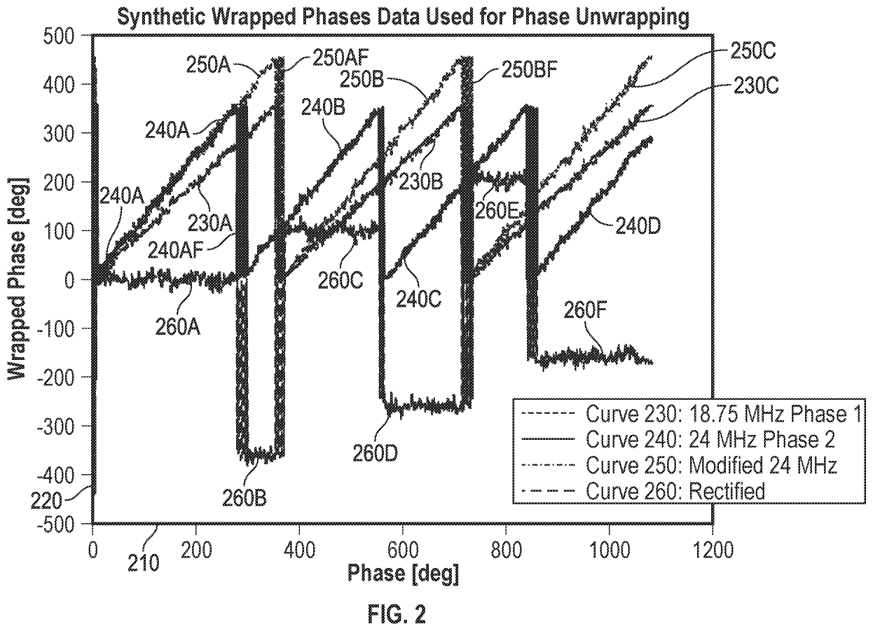

FIG. 2 illustrates sets of overlapped curves that represent how a “rectification” process may be used to help unwrap sets of wrapped data. FIG. 2 includes curves that are similar to curves 130 and 140 of FIG. 1. FIG. 2 includes curve segments curve segments 230A, 230B, and 230C (of curve 230) that may be associated with a frequency of 18.75 MHz like the curve 130 of FIG. 1. FIG. 2 also includes curve segments 240A, 240AF, 240B, 240C, and 240D (of curve 240) that may be associated with a frequency of 24 MHz like the curve 140 of FIG. 1.

Curve segments 250A, 250B, and 250C (have a same slope as curve segments 240A, 240B, and 240C). Curve segments 250A, 250B, and 250C (of curve 250) each begin rising from zero degrees at points respectively where curve segments 230A, 230B, and 230C begin rising from wrapped phases of zero degrees. FIG. 2 also includes curve segments that are identified as items 240AF and 250AF, that respectively show points where wrapped phases of curve segments 240A and 250A return to zero degrees earlier due to the phase noise perturbation and the 2pi module of arctan limitation. Curve segments 250A, 250B, and 250C may be referred to as synthetic phases as these curve segments as they were generated for use in FIG. 2. These synthetic phases may be used when a “rectification” process is performed or may be used as a tool to understand a result of a “rectification” process.

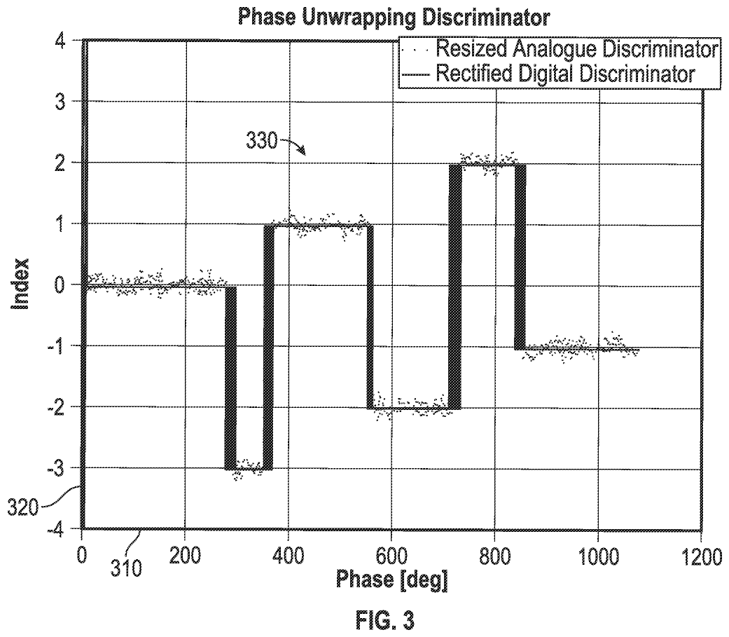

Curve segments 260A, 260B, 260C, 260D, 260E, and 260F are included in curve 260 that is generated by the aforementioned “rectification” process. Each of the different curve segments of curve 260 correspond to a result of the rectification process that is also illustrated in the curves of FIG. 3. Note that transitions in segments of curve 260 from one level to another level of the vertical wrapped phase axis correspond to transitions in one or more of curve segments 230, 240, and 250 back to a wrapped phase of zero degrees.

FIG. 3 illustrates a curve that is similar to the curve 260 of FIG. 2. Instead of using a vertical axis noting wrapped phase degrees, the vertical axis 320 identifies index values assigned to steps of the curve 330 of FIG. 3. The horizontal axis 310 identifies phase degrees like to horizontal axis of FIG. 2. Curve 330 and the index values of the vertical axis 320 may be generated mathematically using a series of equations.

These equations include a formula that generates a ratio (F2/F1)=Fn between a low frequency (F1) of 18.75 MHz and a higher frequency (F2) of 24 MHz. Here the 18.75 MHz and the 24 MHz frequencies may have been selected from a list of “allowed frequencies,” where the ratio of Fn=18.75/24=1.28 is neither an integer nor a rational number composed of two adjacent integers. The formulas used to generate the curve 330 may refer to the ratio of F2/F1 as Fn and these formulas may use variable values that are selected by the designer. For example, a value of a first variable “e” is selected to equal 0.42 and the value of a second variable “nfL” is selected to be 3. Other formulas that may be used to “unwrap” phases of signals include:

delta=360*(Fn−1)

DT=PH2−(PH1*Fn)

UN=DT/delta

res=(360 nfl*delta)/delta

A=UN−res*(sign(e+UN)−1)/2

D=round(A)

The term “delta” in these formulas relates to a difference in phase between F1 and F2 that is a function of ratio Fn, here delta=360*(Fn−1)=360*(1.28-1)=100.8. Since frequency F1 is a lower frequency than frequency F2, a phase of a signal at frequency F1 changes more slowly over the same time than the phase of a signal at frequency F2. When a phase (phase_1) of the F1 frequency signal changes by X degrees, the phase (phase_2) of the F2 frequency signal will change according to the formula phase_2=phase_1 (Fn). A value of a variable DT may be calculated by the formula DT=phase_2−phase_1*Fn.

The variable “UN” may be referred to as an unwrapped number. From the variable “A,” a value for variable “D” may be determined by rounding a value for A to a whole number. The variable D is the index value of the vertical axis of FIG. 3. The sign function used to determine the value of A is sometimes represented as “sgn.” A numeric value sign (X) is equal to 1 for any number X that is greater than zero, is equal to −1 for any number X that is less than zero and is equal to zero when X=zero.

When PH1=is 156.25 degrees, a phase angle associated with PH2 will equal 156.25*1.28=200 degrees. At this time the value of variable DT=200-156.25 (1.28)=0. Values of “PH1” and “PH2” may be identified from a stored set of data or from phases derived from curves 230 and 240 of FIG. 2. For example, a wrapped PH2 of 200 degrees may be used to interpolate a value for PH1. Such an interpolation may be performed by drawing a horizontal line from the 200 degree point on the vertical axis 220 of FIG. 2 to curve segment 240A, then by drawing a vertical line to a point on curve segment 230A, and then by drawing another horizontal line back to the vertical axis 220. Similar mappings may be performed to interpolate a value of PH2 from a value of PH1 using the curves 230 and 240 of FIG. 2. These numbers may also be identified mathematically.

Table 1 illustrates values at certain phase relationships when F1=18.75 MHz, F2=24 MHz, e=0.42, and nfL=3. From these numbers, values of variable “res” (or residual offset), Fn, and delta may be derived (res=0.05714, Fn=1.28, and delta=100.8). Note that the value of index (variable D) in table 1 corresponds to the graph of FIG. 3.

TABLE 1

| F1 | 18.75 | | MHz | | | | |
|---|---|---|---|---|---|---|---|
| F2 | 24 | | Mhz | | | | |
| e | e = 0.42 | | | | | | |
| delta | delta = 100.8 | | | | | | |
| nfL | nfL = 3 | | | | | | |
| res | res = 0.5714 | | | | | | |
| Fn = F2/F1 | Fn = 24/18.75 = 1.28 | | | | | | |
| PH1 | F1 phase | 156.25 | 352 | 25 | 250 | 90 | 280 |
| PH2 | F2 phase | 200 | 50 | 150 | 50 | 300 | 200 |
| DT | DT = PH2 − PH1 * Fn | 0 | −400.56 | 118 | −270 | 184.8 | −158.4 |
| UN | UN = DT/delta | 0 | −3.9738 | 1.1706 | −2.67857 | 1.83333 | −1.571 |
| | e + UN | 0.42 | −3.5538 | 1.5906 | −2.25857 | 2.25333 | −1.151 |
| | sign (e + UN) | 1 | −1 | 1 | −1 | 1 | −1 |
| | sign (e + UN) − 1 | 0 | −2 | 0 | −2 | −2 | −2 |
| | (sign (e + UN) − 1)/2 | 0 | −1 | 0 | −1 | −1 | −1 |
| | res * (sign (e + UN) − 1)/2 | 0 | −0.5714 | 0 | −0.5714 | −0.5714 | −0.571 |
| A | A = UN − | 0 | −3.4024 | 1.1706 | −2.10717 | 2.40473 | −1 |
| | res*(sign(e + UN) − 1)/2 | | | | | | |
| D | D = round A | 0 | −3 | 1 | −2 | 2 | −1 |

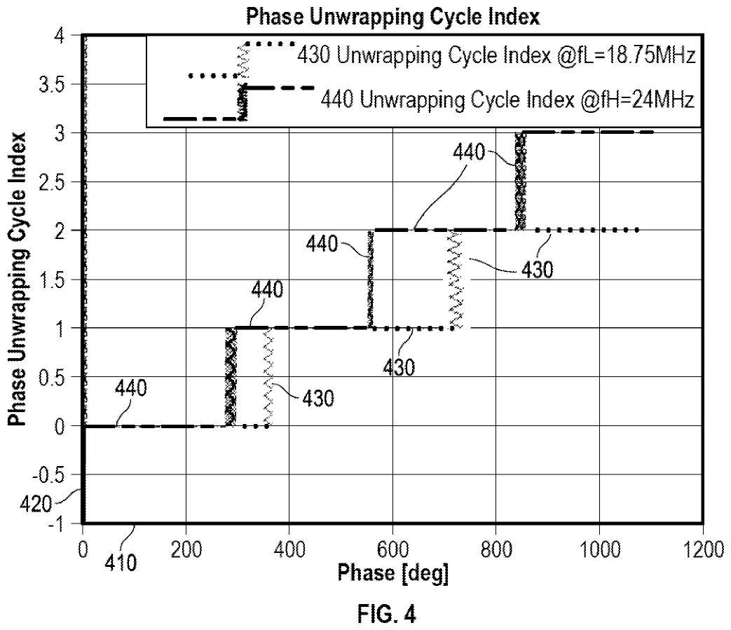

FIG. 4 illustrates another set of curves that show a correspondence between phase in degrees and an unwrapped cycle index of the 18.75 MHz and 24 MHz signals. The curves of FIG. 4 may have been produced after performing a second set of equations when a reference frequency df=F2−F1+1=5.25+1=6.25 MHz is used. FIG. 4 includes vertical axis 420 that shows values of a phase unwrapping cycle index and a horizontal axis 410 of total degrees. Variables CL and CH in the equations below correspond to values of curve 430 and 440 of FIG. 4 along vertical axis 420.

nL=FL/df=18.75/6.25=3

nH=nL+1=3+1=4

CL=nL*(1−sign(e+D))/2+D

CH=nH*(1−sign(e+D))/2+D

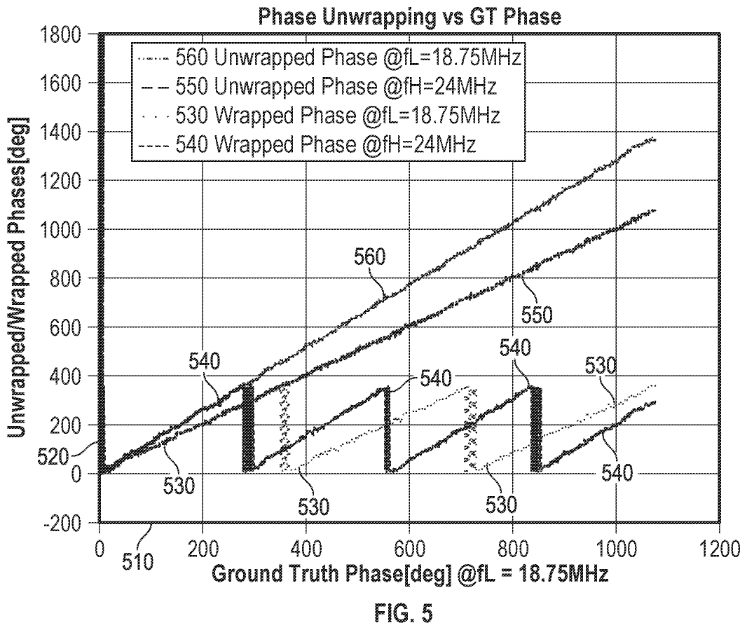

Table 2 illustrates the results of several exemplary calculations associated with the phase relationships PH1 and PH2 of in table 1. FIG. 5 illustrates that values of certain variables (CL and CH) may be used to generate other phase diagram that plots phase relationships between the 18.75 MHz signal and the 24 MHz signal as these signals propagate over a distance.

TABLE 2

| PH1 | F1 phase | 156.25 | 352 | 25 | 250 | 90 | 280 |
|---|---|---|---|---|---|---|---|
| PH2 | F2 phase | 200 | 50 | 150 | 50 | 300 | 200 |
| nL = F1/df | nL = F1/df | 3 | 3 | 3 | 3 | 3 | 3 |
| nH = nL + 1 | nH = nL + 1 | 4 | 4 | 4 | 4 | 4 | 4 |
| sign(e + D) | sign(e + D) | 1 | −1 | 1 | −1 | 1 | −1 |
| | 1-sign(e + D) | 0 | 2 | 0 | 2 | 0 | 2 |
| | 1-sign(e + D)/2 | 0 | 1 | 0 | 1 | 0 | 1 |
| CL | CL = nL*(1 − | 0 | 0 | 1 | 1 | 2 | 2 |
| | sign(e + D))/2 + D | | | | | | |
| CH | CH = nH*(1 − | 0 | 1 | 1 | 2 | 2 | 3 |
| | sign(e + D))/2 + D | | | | | | |

FIG. 5 includes a vertical axis of unwrapped and wrapped phase degrees 520 and a horizontal axis 510 of ground truth in degrees. FIG. 5 includes wrapped phases of frequency F1=18.75 MHz (curve 530) and wrapped phases of frequency F2=24 MHz (curve 540). FIG. 5 also shows unwrapped phases of the 18.75 MHz signal 550 and unwrapped phases of the 24 MHz signal 560. Note that the unwrapped phase curves 550 and 560 are lines. Here line 550 corresponds to the equation P1=PH1+360*CL and line 560 corresponds to the equation P2=PH2+360*CH.

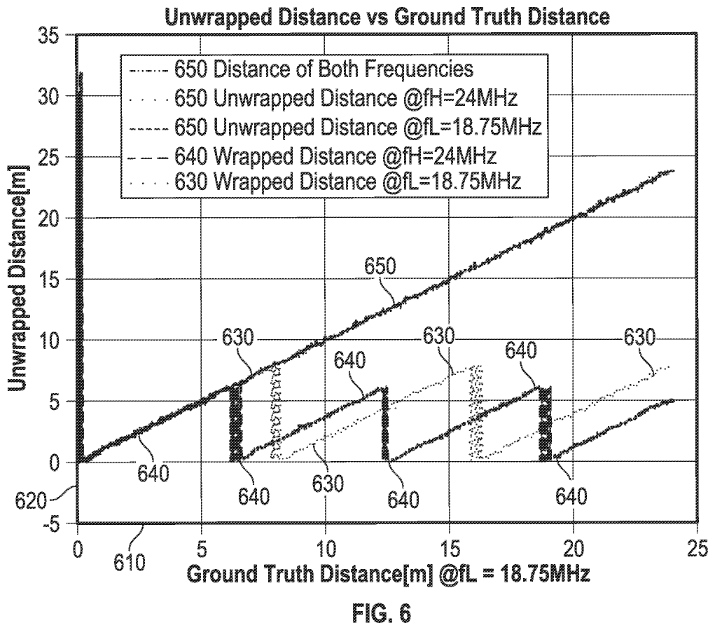

FIG. 6 illustrates a series of curves that represent signals of 18.75 MHz and 24 MHz as they propagate over distance. FIG. 6 includes a horizontal axis of ground truth distance (i.e. total distance) in meters and a vertical distance of unwrapped distance in meters. FIG. 6 includes curve 630 that is a wrapped distance associated with the frequency F1=18.75 MHz and curve 640 that is a wrapped distance associated with the frequency F2=24 MHz. Note that the rising portions of curves 630 and 640 have a same slope, this is because signals of different frequencies travel at a same speed (the speed of light C). FIG. 6 also includes curve 650 that is an overlaps first rising portions of curves 630 and 640. The curves of FIG. 6 may be derived from yet another series of equations that are not reviewed here.

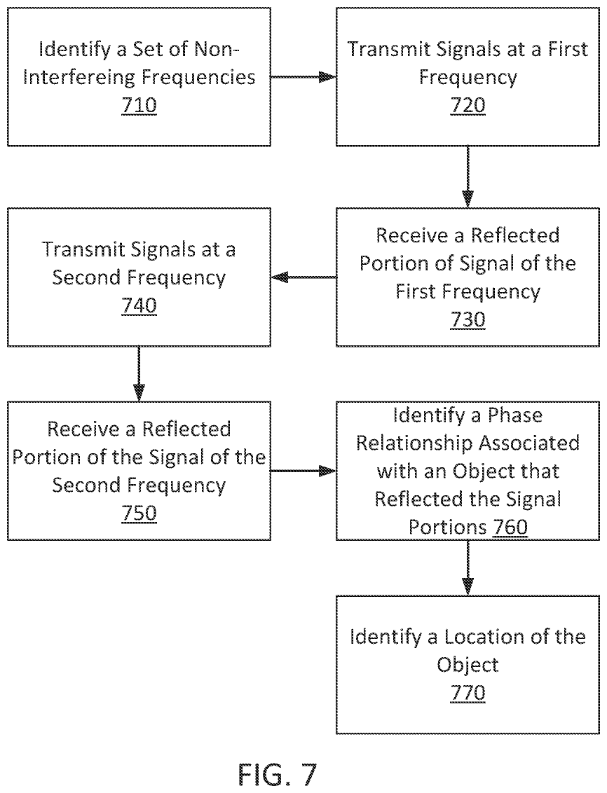

FIG. 7 illustrates a series of steps that may be performed by a detection apparatus using frequencies that may have been classified as non-interfering frequencies. As mentioned above, these non-interfering frequencies may be frequencies that are not used by equipment that may be affected by signals originating from a detection device. While signals transmitted from such a detection device may be light signals, such light signals may have been generated using electrical signals that may escape from the detection device as EMI when that detection device operates.

In step 710, a set of non-interfering frequencies may be identified. Here at least one of these non-interfering frequencies may have a value that is an irrational number or a frequency that is not represented as an integer. In one instance, two different frequencies may be identified in step 710 and as discussed above one of these frequencies may be of 18.75 MHz and another frequency may be 24 MHz. Next in step 720 a detection signal, in the form of light, may be transmitted from the detection device and a portion of that signal may bounce off of an object and that portion of the reflected signal may be received in step 730 of FIG. 7. After step 730, a signal of a second frequency may be transmitted in step 740 and a reflected portion of that signal of the second frequency may be received in step 750. After step 750, a phase relationship associated with the received signal portions may be received in step 760 and a location of the 3-dimensional object that may result in different wrapped phases, may be identified in step 770.

The steps of FIG. 7 may be performed based on identifying phase relationships associated with sets of wrapped phases of the frequencies where at least two different frequencies are used. These two different frequencies may also may not be evenly divisible by a signal number or a rational number and these two different frequencies may not be multiples of each other. Ideal phase relationships associated with these two different frequencies may not repeat over several periods. By associating index numbers with different portions of wrapped signals as discussed in respect to FIGS. 2-3, these index numbers may be used to identify a wrapped phase that is associated with a location where an object that reflected the signals is located. Differences in phase between signals of different frequencies combined with the index value may be used to identify how far an object is from a detection device. Here an index value of zero may be associated with a first wrapped phase of a higher frequency signal and an index value of minus three may be associated with a second wrapped phase of the higher frequency and a first wrapped phase of a lower frequency. An index value of one may be associated with the second wrapped phase of the higher frequency signal and an index value of minus two may be associated with a third wrapped phase of the higher frequency and a second wrapped phase of the lower frequency. An index value of two may be associated with a third wrapped phase of the higher frequency signal and an index value of minus one may be associated with a fourth wrapped phase of the higher frequency and a third wrapped phase of the lower frequency.

An index value and a phase difference may then be used to identify the location of the object, for example, by accessing a lookup table. Referred to FIG. 2 and based on the said method we can make a lookup table (LUT). We use the same system frequency pairs of 24 MHz and 18.75 MHz we have

| DT values [deg] | 206A | 206B | 206C | 206D | 206E | 206F |
|---|---|---|---|---|---|---|
| DT @F1 = 18.75 MHz F2 = 24 MHz | 0 | −360 | 100.08 | −259.2 | 201.6 | −158.4 |
| CL value | 0 | 0 | 1 | 1 | 2 | 2 |
| CH value | 0 | 1 | 1 | 2 | 2 | 3 |

The DT value in the LUT is in an ideal case without noise, while in the measurement process the data is nosy. We can calculate the noisy DT values based on the wrapped phase. For instance by using the same phase values in Tab. 1:

| | | | | | | | |
|---|---|---|---|---|---|---|---|
| DT | DT = PH2 − PH1 * Fn | 0 | −400.56 | 118 | −270 | 184.8 | −158.4 |

For instance the DT value of −400.56 degree is mostly closing to LUT value −360 degree, thus we have CL=0 and CH=1; further DT values of 118 is mostly closing to LUT value of 100.08 degree, thus we have CL=1 and CH=1. such that we check every DT value to find the cycle number of CL and CH to perform unwrapping signal processing.

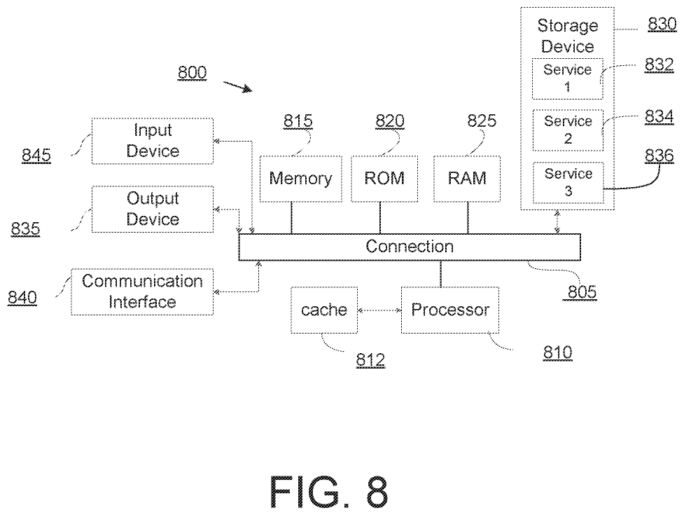

FIG. 8 shows an example of computing system 800 that may be used to implement at least some of the functions reviewed in the present disclosure. In certain instances, a computing device may be incorporated into a sensing apparatus or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random-access memory (RAM) 825 to processor 810. Computing system 800 can include a cache of high-speed memory 812 connected directly with, near, or integrated as part of processor 810.

Processor 810 can include any general-purpose processor and a hardware service or software service, such as services 842, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement, and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

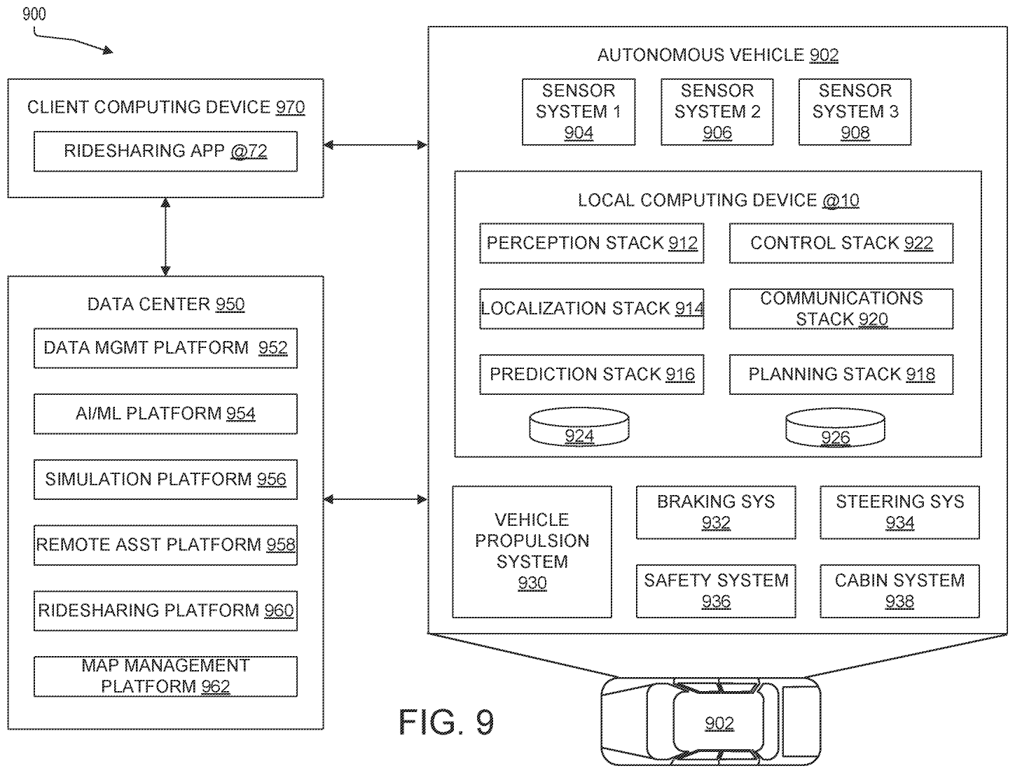

FIG. 9 illustrates an example of an AV management system 900. One of ordinary skill in the art will understand that, for the AV management system 900 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 900 includes an AV 902, a data center 980, and a client computing device 970. The AV 902, the data center 950, and the client computing device 970 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 902 can navigate roadways without a human driver based on sensor signals generated by multiple sensor systems 904, 906, and 908. The sensor systems 904-908 can include different types of sensors and can be arranged about the AV 902. For instance, the sensor systems 904-908 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 904 can be a camera system, the sensor system 906 can be a LIDAR system, and the sensor system 908 can be a RADAR system. Other embodiments may include any other number and type of sensors.

The AV 902 can also include several mechanical systems that can be used to maneuver or operate the AV 902. For instance, the mechanical systems can include a vehicle propulsion system 930, a braking system 932, a steering system 934, a safety system 936, and a cabin system 938, among other systems. The vehicle propulsion system 930 can include an electric motor, an internal combustion engine, or both. The braking system 932 can include an engine brake, brake pads, actuators, and/or any other suitable componentry configured to assist in decelerating the AV 902. The steering system 934 can include suitable componentry configured to control the direction of movement of the AV 902 during navigation. The safety system 936 can include lights and signal indicators, a parking brake, airbags, and so forth. The cabin system 938 can include cabin temperature control systems, in-cabin entertainment systems, and so forth. In some embodiments, the AV 902 might not include human driver actuators (e.g., steering wheel, handbrake, foot brake pedal, foot accelerator pedal, turn signal lever, window wipers, etc.) for controlling the AV 902. Instead, the cabin system 938 can include one or more client interfaces (e.g., Graphical User Interfaces (GUIs), Voice User Interfaces (VUIs), etc.) for controlling certain aspects of the mechanical systems 930-938.

The AV 902 can additionally include a local computing device 910 that is in communication with the sensor systems 904-908, the mechanical systems 930-938, the data center 950, and the client computing device 970, among other systems. The local computing device 910 can include one or more processors and memory, including instructions that can be executed by the one or more processors. The instructions can make up one or more software stacks or components responsible for controlling the AV 902; communicating with the data center 950, the client computing device 970, and other systems; receiving inputs from riders, passengers, and other entities within the AV's environment; logging metrics collected by the sensor systems 904-908; and so forth. In this example, the local computing device 910 includes a perception stack 912, a mapping and localization stack 914, a prediction stack 916, a planning stack 918, a communications stack 920, a control stack 922, an AV operational database 924, and an HD geospatial database 926, among other stacks and systems.

The perception stack 912 can enable the AV 902 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 904-908, the mapping and localization stack 914, the HD geospatial database 926, other components of the AV, and other data sources (e.g., the data center 950, the client computing device 970, third party data sources, etc.). The perception stack 912 can detect and classify objects and determine their current locations, speeds, directions, and the like. In addition, the perception stack 912 can determine the free space around the AV 902 (e.g., to maintain a safe distance from other objects, change lanes, park the AV, etc.). The perception stack 912 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 914 can determine the AV's position and orientation (pose) using different methods from multiple systems (e.g., GPS, IMUs, cameras, LIDAR, RADAR, ultrasonic sensors, the HD geospatial database 926, etc.). For example, in some embodiments, the AV 902 can compare sensor data captured in real-time by the sensor systems 904-908 to data in the HD geospatial database 926 to determine its precise (e.g., accurate to the order of a few centimeters or less) position and orientation. The AV 902 can focus its search based on sensor data from one or more first sensor systems (e.g., GPS) by matching sensor data from one or more second sensor systems (e.g., LIDAR). If the mapping and localization information from one system is unavailable, the AV 902 can use mapping and localization information from a redundant system and/or from remote data sources.

The prediction stack 916 can receive information from the localization stack 914 and objects identified by the perception stack 912 and predict a future path for the objects. In some embodiments, the prediction stack 916 can output several likely paths that an object is predicted to take along with a probability associated with each path. For each predicted path, the prediction stack 916 can also output a range of points along the path corresponding to a predicted location of the object along the path at future time intervals along with an expected error value for each of the points that indicates a probabilistic deviation from that point.

The planning stack 918 can determine how to maneuver or operate the AV 902 safely and efficiently in its environment. For example, the planning stack 918 can receive the location, speed, and direction of the AV 902, geospatial data, data regarding objects sharing the road with the AV 902 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 902 from one point to another and outputs from the perception stack 912, localization stack 914, and prediction stack 916. The planning stack 918 can determine multiple sets of one or more mechanical operations that the AV 902 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 918 can select from multiple backup plans to carry out. For example, while preparing to change lanes to turn right at an intersection, another vehicle may aggressively cut into the destination lane, making the lane change unsafe. The planning stack 918 could have already determined an alternative plan for such an event. Upon its occurrence, it could help direct the AV 902 to go around the block instead of blocking a current lane while waiting for an opening to change lanes.

The control stack 922 can manage the operation of the vehicle propulsion system 930, the braking system 932, the steering system 934, the safety system 936, and the cabin system 938. The control stack 922 can receive sensor signals from the sensor systems 904-908 as well as communicate with other stacks or components of the local computing device 910 or a remote system (e.g., the data center 950) to effectuate operation of the AV 902. For example, the control stack 922 can implement the final path or actions from the multiple paths or actions provided by the planning stack 918. This can involve turning the routes and decisions from the planning stack 918 into commands for the actuators that control the AV's steering, throttle, brake, and drive unit.

The communications stack 920 can transmit and receive signals between the various stacks and other components of the AV 902 and between the AV 902, the data center 950, the client computing device 970, and other remote systems. The communications stack 920 can enable the local computing device 910 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 920 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 926 can store HD maps and related data of the streets upon which the AV 902 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 924 can store raw AV data generated by the sensor systems 904-908, stacks 912-922, and other components of the AV 902 and/or data received by the AV 902 from remote systems (e.g., the data center 950, the client computing device 970, etc.). In some embodiments, the raw AV data can include HD LIDAR point cloud data, image data, RADAR data, GPS data, and other sensor data that the data center 950 can use for creating or updating AV geospatial data or for creating simulations of situations encountered by AV 902 for future testing or training of various machine learning algorithms that are incorporated in the local computing device 910.

The data center 950 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 950 can include one or more computing devices remote to the local computing device 910 for managing a fleet of AVs and AV-related services. For example, in addition to managing the AV 902, the data center 950 may also support a ridesharing service, a delivery service, a remote/roadside assistance service, street services (e.g., street mapping, street patrol, street cleaning, street metering, parking reservation, etc.), and the like.

The data center 950 can send and receive various signals to and from the AV 902 and the client computing device 970. These signals can include sensor data captured by the sensor systems 904-908, roadside assistance requests, software updates, ridesharing pick-up and drop-off instructions, and so forth. In this example, the data center 950 includes a data management platform 952, an Artificial Intelligence/Machine Learning (AI/ML) platform 954, a simulation platform 956, a remote assistance platform 958, and a ridesharing platform 960, and a map management platform 962, among other systems.

The data management platform 952 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 950 can access data stored by the data management platform 952 to provide their respective services.

The AI/ML platform 954 can provide the infrastructure for training and evaluating machine learning algorithms for operating the AV 902, the simulation platform 956, the remote assistance platform 958, the ridesharing platform 960, the map management platform 962, and other platforms and systems. Using the AI/ML platform 954, data scientists can prepare data sets from the data management platform 952; select, design, and train machine learning models; evaluate, refine, and deploy the models; maintain, monitor, and retrain the models; and so on.

The simulation platform 956 can enable testing and validation of the algorithms, machine learning models, neural networks, and other development efforts for the AV 902, the remote assistance platform 958, the ridesharing platform 960, the map management platform 962, and other platforms and systems. The simulation platform 956 can replicate a variety of driving environments and/or reproduce real-world scenarios from data captured by the AV 902, including rendering geospatial information and road infrastructure (e.g., streets, lanes, crosswalks, traffic lights, stop signs, etc.) obtained from a cartography platform (e.g., map management platform 962); modeling the behavior of other vehicles, bicycles, pedestrians, and other dynamic elements; simulating inclement weather conditions, different traffic scenarios; and so on.

The remote assistance platform 958 can generate and transmit instructions regarding the operation of the AV 902. For example, in response to an output of the AI/ML platform 954 or other system of the data center 950, the remote assistance platform 958 can prepare instructions for one or more stacks or other components of the AV 902.

The ridesharing platform 960 can interact with a customer of a ridesharing service via a ridesharing application 972 executing on the client computing device 970. The client computing device 970 can be any type of computing system, including a server, desktop computer, laptop, tablet, smartphone, smart wearable device (e.g., smartwatch, smart eyeglasses or other Head-Mounted Display (HMD), smart earpods/earbuds, or other smart in-ear, on-ear, or over-ear device, etc.), gaming system, or other general purpose computing device for accessing the ridesharing application 972. The client computing device 970 can be a customer's mobile computing device or a computing device integrated with the AV 902 (e.g., the local computing device 910). The ridesharing platform 960 can receive requests to pick up or drop off from the ridesharing application 972 and dispatch the AV 902 for the trip.

Map management platform 962 can provide a set of tools for the manipulation and management of geographic and spatial (geospatial) and related attribute data. The data management platform 952 can receive LIDAR point cloud data, image data (e.g., still image, video, etc.), RADAR data, GPS data, and other sensor data (e.g., raw data) from one or more AVs 902, Unmanned Aerial Vehicles (UAVs), satellites, third-party mapping services, and other sources of geospatially referenced data. The raw data can be processed, and map management platform 962 can render base representations (e.g., tiles (2D), bounding volumes (3D), etc.) of the AV geospatial data to enable users to view, query, label, edit, and otherwise interact with the data. Map management platform 962 can manage workflows and tasks for operating on the AV geospatial data. Map management platform 962 can control access to the AV geospatial data, including granting or limiting access to the AV geospatial data based on user-based, role-based, group-based, task-based, and other attribute-based access control mechanisms. Map management platform 962 can provide version control for the AV geospatial data, such as to track specific changes that (human or machine) map editors have made to the data and to revert changes when necessary. Map management platform 962 can administer release management of the AV geospatial data, including distributing suitable iterations of the data to different users, computing devices, AVs, and other consumers of HD maps. Map management platform 962 can provide analytics regarding the AV geospatial data and related data, such as to generate insights relating to the throughput and quality of mapping tasks.

In some embodiments, the map viewing services of map management platform 962 can be modularized and deployed as part of one or more of the platforms and systems of the data center 950. For example, the AI/ML platform 954 may incorporate the map viewing services for visualizing the effectiveness of various object detection or object classification models, the simulation platform 956 may incorporate the map viewing services for recreating and visualizing certain driving scenarios, the remote assistance platform 958 may incorporate the map viewing services for replaying traffic incidents to facilitate and coordinate aid, the ridesharing platform 960 may incorporate the map viewing services into the client application 972 to enable passengers to view the AV 902 in transit en route to a pick-up or drop-off location, and so on.

What is claimed is:

1. A computer-implemented method comprising:
selecting a first frequency and a second frequency from a set of non-interfering frequencies, wherein a repetition rate of the first frequency or the second frequency is an irrational number associated with a ratio of the first frequency and the second frequency or the ratio of the first frequency and the second frequency is not composed of two adjacent integer numbers;
transmitting a first signal at the first frequency;
receiving a reflected portion of the first signal after the reflected portion of the signal is reflected off of an object;
transmitting a second signal at the second frequency;
receiving a reflected portion of the second signal after the second portion of the second signal is reflected off the object; and
identifying phase relationship data associated with the object based on the reflected portion of the first signal and the reflected portion of the second signal.

2. The computer-implemented method of claim 1, further comprising:
identifying a location of the object based on a correspondence of the phase relationship data associated with the object with the ratio of the first frequency to the second frequency.

3. The computer-implemented method of claim 2, further comprising:
storing data associated with a period of the first frequency to associate with a wrapped first phase mapping that includes a first number of periods of the first frequency; and
storing data associated with a period of the second frequency to associate with the first phase mapping, wherein the phase mapping includes a second number of periods of the second frequency and wherein the second number of periods is larger than the first number of periods.

4. The computer-implemented method of claim 3, further comprising:
associating a first portion of a first period of the first frequency with a first index value of a second mapping that maps index values to phase values, wherein the first portion of the first period of the first frequency spans a first number of degrees that is less than 360 degrees of the first frequency;
associating a second index value of the second mapping with a second number of degrees of the first frequency that spans from the first number of degrees of the first frequency to the 360 degrees of the first frequency; and
associating a third index value of the second mapping with a first portion of a second period of the second frequency.

5. The computer-implemented method of claim 4, further comprising:
identifying that the location of the object corresponds to a phase associated with the first index value, wherein the location of the object is identified based on a number of degrees of the phase relationship data and the association with the first index value.

6. The computer-implemented method of claim 4, further comprising:
identifying that the location of the object corresponds to a phase associated with the second index value, wherein the location of the object is identified based on a number of degrees of the phase relationship data being associated with the second index value.

7. The computer-implemented method of claim 4, further comprising:
identifying that the location of the object corresponds to a phase associated with the third index value, wherein the location of the object is identified based on a number of degrees of the phase relationship data being associated with the third index value.

8. The computer-implemented method of claim 1, further comprising:
identifying a value to associate with the phase relationship data such that a location of the object can be identified; and
identifying a location of the object based on the identified value and the identified phase relationship data.

9. The computer-implemented method of claim 8, wherein the value associated with the phase relationship data is an index value of a plurality of index values that correspond to a mapping of changing phases of the first and the second frequency.

10. The computer-implemented method of claim 8, further comprising:
accessing a lookup table to identify the location of the object based on the identified value and the phase relationship data being associated with data stored at the lookup table.

11. The computer-implemented method of claim 1, wherein the ratio has a non-integer value.

12. A non-transitory computer-readable storage media having embodied thereon a program executable by a processor to implement a method comprising:
selecting a first frequency and a second frequency from a set of non-interfering frequencies, wherein a repetition rate of the first frequency or the second frequency is an irrational number associated with a ratio of the first frequency and the second frequency;
transmitting a first signal at the first frequency;
receiving a reflected portion of the first signal after the reflected portion of the signal is reflected off of an object;
transmitting a second signal at the second frequency;
receiving a reflected portion of the second signal after the second portion of the second signal is reflected off the object; and
identifying phase relationship data associated with the object based on the reflected portion of the first signal and the reflected portion of the second signal.

13. The non-transitory computer-readable storage media of claim 12, the program further executable to:
identify a location of the object based on a correspondence of the phase relationship data associated with the object with the ratio of the first frequency to the second frequency.

14. The non-transitory computer-readable storage media of claim 13, the program further executable to:
store data associated with a period of the first frequency to associate with a wrapped first phase mapping that includes a first number of periods of the first frequency; and
store data associated with a period of the second frequency to associate with the first phase mapping, wherein the phase mapping includes a second number of periods of the second frequency and wherein the second number of periods is larger than the first number of periods.

15. The non-transitory computer-readable storage media of claim 14, the program further executable to:
associate a first portion of a first period of the first frequency with a first index value of a second mapping that maps index values to phase values, wherein the first portion of the first period of the first frequency spans a first number of degrees that is less than 360 degrees of the first frequency;
associate a second index value of the second mapping with a second number of degrees of the first frequency that spans from the first number of degrees of the first frequency to the 360 degrees of the first frequency; and
associate a third index value of the second mapping with a first portion of a second period of the second frequency.

16. The non-transitory computer-readable storage media of claim 15, the program further executable to:
identify that the location of the object corresponds to a phase associated with the first index value, wherein the location of the object is identified based on a number of degrees of the phase relationship data and the association with the first index value.

17. The non-transitory computer-readable storage media of claim 15, the program further executable to:
identify that the location of the object corresponds to a phase associated with the second index value, wherein the location of the object is identified based on a number of degrees of the phase relationship data being associated with the second index value.

18. An apparatus comprising:
a memory;
a processor that executes instructions out of the memory to:
select a first frequency and a second frequency from a set of non-interfering frequencies, wherein a repetition rate of the first frequency or the second frequency is an irrational number associated with a ratio of the first frequency and the second frequency; and
a transceiver that:
transmits a first signal at the first frequency,
receives a reflected portion of the first signal after the reflected portion of the signal is reflected off of an object,
transmits a second signal at the second frequency, and
receives a reflected portion of the second signal after the second portion of the second signal is reflected off the object, wherein the processor also executes the instructions to identify phase relationship data associated with the object based on the reflected portion of the first signal and the reflected portion of the second signal.

19. The apparatus of claim 18, wherein the processor also executes the instructions to identify a location of the object based on a correspondence of the phase relationship data associated with the object with the ratio of the first frequency to the second frequency.

20. The apparatus of claim 18, further comprising:
a storage device that stores lookup table data, wherein the processor also executes the instructions to access the lookup table data to identify a location of the object based on an identified value and the phase relationship data being associated with data stored at the storage device.
